(19) United States
(12) Patent Application Publication
(10) Pub. No.: US 2026/0023440 A1
(43) Pub. Date: Jan. 22, 2026

(54) GESTURE RECOGNITION METHOD, GESTURE RECOGNITION DEVICE, ELECTRONIC DEVICE, AND COMPUTER-READABLE STORAGE MEDIUM

(71) Applicant: UBTECH ROBOTICS CORP LTD, Shenzhen (CN)

(72) Inventors: YI AN, Shenzhen (CN); Kan Wang, Shenzhen (CN); Pei Dong, Shenzhen (CN); Jichao Jiao, Shenzhen (CN)

(21) Appl. No.: 19/269,033

(22) Filed: Jul. 15, 2025

(30) Foreign Application Priority Data
Jul. 19, 2024 (CN) 202410978609.X

(51) Int. Cl. G06F 3/01; G06V 10/74; G06V 10/80; G06V 10/82; G06V 40/10; G06V 40/20

(52) U.S. Cl. CPC G06F 3/017; G06V 10/761; G06V 10/806; G06V 10/82; G06V 40/10; G06V 40/28

(57) ABSTRACT

A gesture recognition method, a gesture recognition device, an electronic device and a computer-readable storage medium are provided. The gesture recognition method includes steps: obtaining a reference feature vector set including M gesture categories and a gesture category set including M reference feature vectors, where each of the reference feature vectors is obtained by performing vector fusion on initial feature vectors of N sample images of each of the gesture categories, and the initial feature vectors are obtained by performing hand feature extraction on the sample images; performing hand feature extraction on the image to be recognized to obtain a gesture feature vector; and determining a target gesture category of the image to be recognized based on similarities between the gesture feature vector and the M reference feature vectors. The gesture recognition method reduces computational complexity and improves gesture recognition efficiency

### CROSS REFERENCE TO RELATED APPLICATIONS

The present disclosure claims foreign priority to Chinese Patent Application No. 202410978609. X, titled “GESTURE RECOGNITION METHOD, GESTURE RECOGNITION DEVICE, ELECTRONIC DEVICE, AND COMPUTER-READABLE STORAGE MEDIUM”, filed on Jul. 19, 2024 in China National Intellectual Property Administration, and the entire contents of which are hereby incorporated by reference.

### TECHNICAL FIELD

The present disclosure relates to a field of gesture recognition technology, and in particular to a gesture recognition method, a gesture recognition device, an electronic device and a computer-readable storage medium.

### BACKGROUND

Benefiting from rapid development of deep learning, computer vision, and sensor technologies, the application of gesture recognition methods is becoming more and more extensive. Gesture recognition technology in the field of gesture recognition has gradually moved from laboratory to practical application, and has expanded from early gaming and entertainment to a wider range of fields, such as human-computer interaction, smart home and security monitoring.

However, in the related art, it requires to process and analyze a large amount of gesture image data during gesture recognition. For example, in a gesture recognition process based on a deep learning model, when judging gesture categories through a classifier of the deep learning model, a large number of calculation operations is performed on the gesture feature data, which has a high computational complexity. In a case of limited hardware conditions, a gesture recognition speed is slow and there is a problem of low gesture recognition efficiency.

### SUMMARY

Embodiments of the present disclosure provide a gesture recognition method, a gesture recognition device, an electronic device and a computer-readable storage medium. The embodiments of the present disclosure calculate similarities between a gesture feature vector of an image to be recognized and reference feature vectors, and compares a gesture feature of the image to be recognized with gesture category features that are predefined to perform gesture recognition. Each of the gesture category features is obtained by feature extraction and fusing of sample images corresponding to a specific gesture. Therefore, the calculation complexity when determining a target gesture category of the image to be recognized is reduced, and gesture recognition efficiency is effectively improved.

The present disclosure provides the gesture recognition method. The gesture recognition method includes steps:
obtaining a reference feature vector set corresponding to an image to be recognized and a gesture category set; where the gesture category set is predefined and includes M gesture categories; the reference feature vector set includes M reference feature vectors corresponding to the M gesture categories, each of the reference feature vectors is obtained by performing vector fusion on initial feature vectors of N sample images of each of the gesture categories, each of the initial feature vectors is obtained by performing hand feature extraction on each of the sample images, and M and N are integers greater than 1;
performing hand feature extraction on the image to be recognized to obtain a gesture feature vector; and
determining a target gesture category of the image to be recognized based on similarities between the gesture feature vector and the M reference feature vectors in the reference feature vector set.

The present disclosure provides the gesture recognition device. The gesture recognition device includes a data acquisition module, a feature extraction module, and a gesture category determination module.

The data acquisition module is configured to obtain a reference feature vector set corresponding to an image to be recognized and a gesture category set. The gesture category set is predefined and includes M gesture categories. The reference feature vector set includes M reference feature vectors corresponding to the M gesture categories. Each of the reference feature vectors is obtained by performing vector fusion on initial feature vectors of N sample images of each of the gesture categories. Each of the initial feature vectors is obtained by performing hand feature extraction on each of the sample images. M and N are integers greater than 1.

The feature extraction module is configured to perform hand feature extraction on the image to be recognized to obtain a gesture feature vector.

The gesture category determination module is configured to determine a target gesture category of the image to be recognized based on similarities between the gesture feature vector and the M reference feature vectors in the reference feature vector set.

In one embodiment, the gesture recognition device further includes a reference feature vector generation module. The reference feature vector generation module is configured to obtain a first sample image set of each of the gesture categories in the gesture category set. Each first sample image set includes the N sample images of each of the gesture categories. The reference feature vector generation module is further configured to perform hand feature extraction on the N sample images of each first sample image set to obtain the N initial feature vectors of the N sample images of each first sample image set. The reference feature vector generation module is further configured to perform vector fusion on the N initial feature vectors of the N sample images of each first sample image set to obtain the reference feature vectors corresponding to the gesture categories.

In one embodiment, the reference feature vector generation module is further configured to perform hand object detection on the N sample images of each of the gesture categories to obtain N hand object regions corresponding to the N sample images of each of the gesture categories. The reference feature vector generation module is further configured to crop the N hand object regions from the N sample images of each of the gesture categories to obtain local images and perform feature extraction on the local images corresponding to the N hand object regions to obtain the N initial feature vectors of the N sample images of each first sample image set.

In one embodiment, the reference feature vector generation module is further configured to obtain vector elements of each of the N initial feature vectors at element positions in each of the N initial feature vectors in each first sample image set. The reference feature vector generation module is further configured to calculate a mean value of the vector elements of each of the element positions of the N initial feature vectors in each first sample image set to obtain element mean values of the element positions of the N initial feature vectors in each first sample image set. The reference feature vector generation module is further configured to combine the element mean values of the element positions of the N vector elements into a first mean vector of each first sample image set. The reference feature vector generation module is further configured to determine the first mean vector in each first sample image set as a corresponding one of the reference feature vectors corresponding to the gesture categories.

In one embodiment, the reference feature vector generation module is further configured to take P feature elements of each of the initial feature vectors as feature data, configure the gesture categories corresponding to the N initial feature vectors as labeled data and train to obtain a target classification model. P is the number of the feature elements included in each of the N initial feature vectors.

The reference feature vector generation module is further configured to determine, based on a feature evaluation result of each of the N initial feature vectors determined by the target classification model, importance weights of the P feature elements corresponding to each of the N initial feature vectors. The feature evaluation result is a data processing result obtained by evaluating a feature importance degree of each of the N initial feature vectors in a classification process of the target classification model.

The reference feature vector generation module is further configured to perform weighted calculation on the P feature elements of each of the N initial feature vectors based on the importance weights of the P feature elements of each of the N initial feature vectors to obtain N weighted feature vectors of the N initial feature vectors. The reference feature vector generation module is further configured to determine a second mean vector of the N weighted feature vectors and determine the second mean vector as each of the reference feature vectors corresponding to the gesture categories.

In one embodiment, the gesture recognition device further includes a first similarity determination module. The first similarity determination module is configured to perform vector splicing on the M reference feature vectors to obtain a reference feature matrix and perform similarity calculation on the gesture feature vector and the reference feature matrix to obtain a similarity vector. Elements in the similarity vector include the similarities between the gesture feature vector and the M reference feature vectors.

In one embodiment, each of the elements in the similarity vector corresponds to a corresponding one of the gesture categories. The gesture category determination module is further configured to perform normalization processing on the similarity vector to obtain a normalized similarity vector, determine a maximum element value in the normalized similarity vector, and determine a gesture category corresponding to the maximum element value as the target gesture category of the image to be recognized.

In one embodiment, the gesture recognition device further includes a second similarity determination module. The second similarity determination module is configured to perform Fourier transform on the M reference feature vectors in the reference feature vector set to obtain M frequency domain reference feature vectors, perform Fourier transform on the gesture feature vector to obtain a frequency domain gesture feature vector; and perform similarity calculation on the frequency domain gesture feature vector and the M frequency domain reference feature vectors in sequence to obtain the similarities between the gesture feature vector and the M reference feature vectors in the reference feature vector set.

In one embodiment, the feature extraction module is further configured to perform hand object detection on the image to be recognized to obtain a to-be-recognized hand object region corresponding to the image to be recognized.

The feature extraction module is further configured to call a feature extraction unit of a pre-trained image classification model and perform feature extraction on a local image to be recognized corresponding to the to-be-recognized hand object region to obtain the gesture feature vector. The pre-trained image classification model is obtained by training a second sample image set with classification labels. The feature extraction unit is a backbone network unit that completes network parameter adjustment by a back propagation algorithm in a training process of the pre-trained image classification model.

The present disclosure provides the electronic device. The electronic device includes a memory and at least one processor. The memory is configured to store computer-executable instructions. At least one processor is configured to execute the computer-executable instructions stored in the memory to implement the gesture recognition method mentioned above.

The present disclosure provides the computer-readable storage medium. The computer-readable storage medium includes computer-executable instructions stored therein or a computer program stored therein. The computer-executable instructions or the computer program is executed by at least one processor to implement the gesture recognition method mentioned above.

In the present disclosure, the similarities are calculated based on the gesture feature vector of the image to be recognized and the M reference feature vectors. The gesture feature vector of the image to be recognized is compared with the reference feature vectors of the gesture categories that are predefined to perform gesture recognition. Each of the reference feature vectors is obtained by performing feature extraction and fusing of sample images corresponding to a specific gesture category. Therefore, calculation complexity is reduced when determining the target gesture category of the image to be recognized, and gesture recognition efficiency is effectively improved.

### BRIEF DESCRIPTION OF DRAWINGS

FIG. 1A is a flow chart of a gesture recognition method according to one embodiment of the present disclosure.

FIG. 1B is a flow chart of performing hand feature extraction according to one embodiment of the present disclosure.

FIG. 1C is a flow chart of obtaining reference feature vectors according to one embodiment of the present disclosure.

FIG. 1D is a flow chart of determining initial feature vectors according to one embodiment of the present disclosure.

FIG. 1E is a flow chart of determining feature reference matrix by performing vector fusion according to one embodiment of the present disclosure.

FIG. 1F is a flow chart of determining a first mean vector according to one embodiment of the present disclosure.

FIG. 1G is a flow chart of determining similarities according to one embodiment of the present disclosure.

FIG. 1H is another flow chart of determining the similarities according to one embodiment of the present disclosure.

FIG. 1I is another flow chart of determining a target gesture category according to one embodiment of the present disclosure.

FIG. 2A is a schematic diagram of an application flow of a gesture recognition model according to one embodiment of the present disclosure.

FIG. 2B is a schematic diagram of a hand object region according to one embodiment of the present disclosure.

FIG. 3 is a block diagram of a gesture recognition device according to one embodiment of the present disclosure.

FIG. 4 is a block diagram of an electronic device according to one embodiment of the present disclosure.

### DETAILED DESCRIPTION

In order to make the objectives, technical solutions, and characteristics of the present disclosure clear, the present disclosure is described in detail with reference to the accompanying drawings, and the described embodiments are not considered as limitations to the present disclosure, and all other embodiments obtained by those skilled in the art without creative efforts shall fall within the protection scope of the present disclosure.

In the description of the present disclosure, reference is made to “some embodiments”, which describe a subset of all possible embodiments, but it is to be understood that “some embodiments” may be the same subset or different subsets of all possible embodiments and may be combined with each other without conflict.

In the description of the present disclosure, the terms “first”, “second”, and “third” involved are for distinguishing similar objects, and do not represent a specific order for the similar objects. It is understood that the terms “first”, “second”, and “third” may be interchanged with a particular order or sequence when allowed, so that the embodiments of the present disclosure described herein can be implemented in an order other than illustrated or described herein.

In the embodiments of the present disclosure, the term “module” or “unit” refers to a computer program or a part of a computer program having a predetermined function, and works with other related parts to implement a predetermined target, and may be implemented completely or partially by using software, hardware (for example, a processing circuit or a memory), or a combination thereof. Similarly, a processor (or a plurality of processors or memories) may be configured to implement one or more modules or units. In addition, each module or each unit may be a part of an overall module or an overall unit having functions of each module or each unit.

Unless otherwise defined, all technical terms and scientific terms used in the embodiments of the present disclosure have the same meaning as commonly understood by those skilled in the art. Terms used in the embodiments of the present disclosure are merely intended to describe objectives of the embodiments of the present disclosure, and are not intended to limit the present disclosure.

In the embodiments of the present disclosure, when data collection processing is applied to the instance application, it should strictly follow requirements of related laws and regulations to obtain the informed consent or separate consent of the personal information subject, and subsequent data use and processing should be carried out within the scope of authorization of the related laws and regulations and the personal information subject.

Before further describing the embodiments of the present disclosure in detail, the terms involved in the embodiments of the present disclosure are explained. The terms involved in the embodiments of the present disclosure are subject to the following interpretations.

1) Network parameters refer to variables inside network units. The variables are adjusted through learning algorithms during training so that the network units are capable of performing specific tasks accurately. For instance, the network parameters include weights and biases in the network units.

2) Training Data refers to a data set configured to train models. The training data generally includes feature data and corresponding labeled data. The model predicts or classifies rules and patterns in the training data. The quality and quantity of training data have a critical impact on the performance and accuracy of the model.

3) Labelled data refers to each data (i.e., each sample such as an image, a piece of text, or a transaction record) with a corresponding label or a target value in a data set. The label or the target value of each data is defined in advance and is commonly a desired predicted result of the mode. For instance, in an image recognition task, the image and a corresponding category (such as “cat”, “dog”, etc.) are labeled data. In an email classification task, an email and a corresponding category (such as “spam” and “non-spam”) are also labeled data. The labeled data is the basis of supervised learning because supervised learning algorithms need to use the labeled data to train a model to enable the model to predict unlabeled data.

4) Feature data refers to data configured to describe all the information in each sample of the data set. In machine learning, feature data is an input variable configured to predict a corresponding label. Features are attributes extracted from the data that are meaningful to the model, and features represent key information in the data. For example, in a house price prediction model, feature data may include a region of a house, the number of rooms of the house, the year of construction, etc. In a recommendation system, feature data may include the historical purchase history of a user, browsing history, ratings, etc. Selecting and constructing effective features is critical to the performance of the model.

5) Fourier transform refers to an important mathematical tool for converting a function or signal from a time domain (or spatial domain) to a frequency domain. Fourier transform makes it easier to analyze and process frequency components of the signal or the function, helping to recognize and analyze the frequency components of the signal.

6) Object detection is an important task in a field of computer vision, aiming to recognize and locate the location and range of one or more objects in an image. In an object detection task, it is generally necessary to recognize a target object in the image and provide a bounding box and corresponding category label for each recognized target.

The present disclosure provides a gesture recognition method, in which similarities between a gesture feature vector of an image to be recognized and reference feature vectors are calculated, and a gesture feature of the image to be recognized is compared with gesture features of the gesture categories that are predefined to perform gesture recognition. Each of the reference feature vectors is obtained by feature extraction and fusing of sample images corresponding to a specific gesture category. Therefore, the calculation complexity is reduced when determining a target gesture category of the image to be recognized, and gesture recognition efficiency is effectively improved.

Before explaining the gesture recognition method of the present disclosure, an example application of a gesture recognition device according to one embodiment of the present disclosure is described as follows. The gesture recognition device in the embodiment of the present disclosure is an electronic device configured to implement the gesture recognition method. In one embodiment, the gesture recognition device (i.e., an electronic device) in the embodiment of the present disclosure may be a server. The server is an independent physical server, a server cluster composed of a plurality of first physical servers, or a distributed system composed of a plurality of second physical servers. Alternatively, the server is a cloud server providing basic cloud computing services such as a cloud service, a cloud database, cloud computing, cloud function, cloud storage, a network service, cloud communication, a middleware service, a domain name service, a security service, a content delivery network (CDN), big data, and an AI platform. The servers are directly or indirectly connected in a wired communication manner or a wireless communication manner, which is not limited thereto. Alternatively, the electronic device in the embodiment of the present disclosure may be a terminal, such as a laptop, a tablet, a desktop computer, a set-top box, a smartphone, a smart speaker, a smart watch, a smart television, or a vehicle-mounted terminal. Alternatively, the electronic devices of the embodiment of the present disclosure may be a combination of the terminal device and the server.

The gesture recognition method provided by the embodiment of the present disclosure is described in detail in connection with the accompanying drawings.

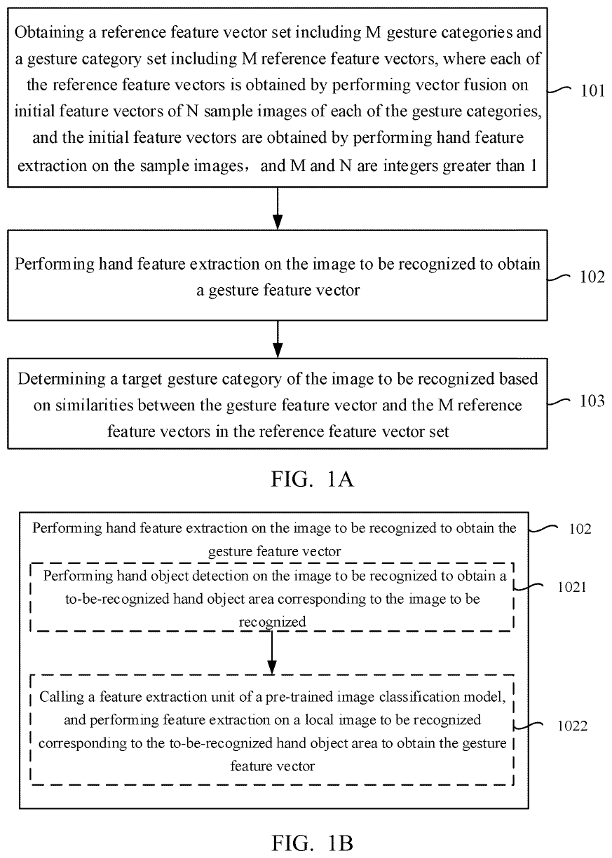

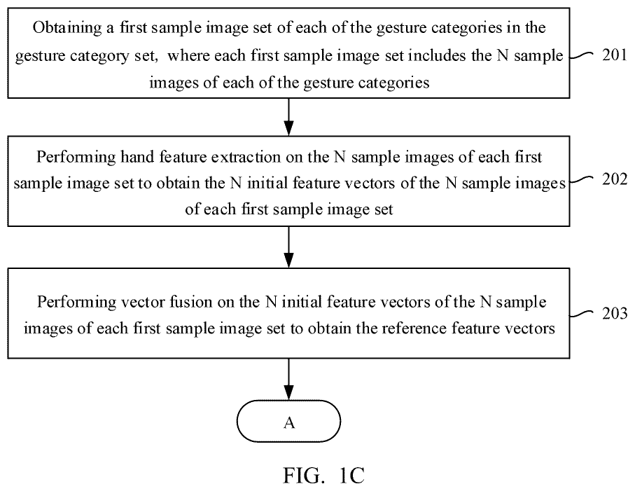

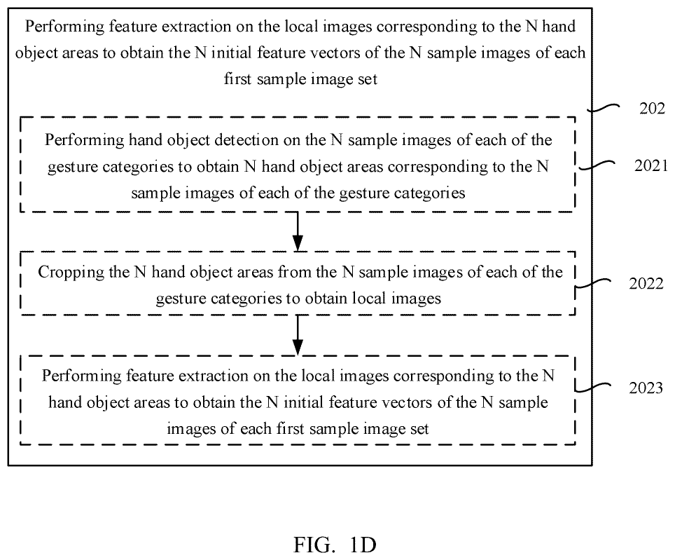

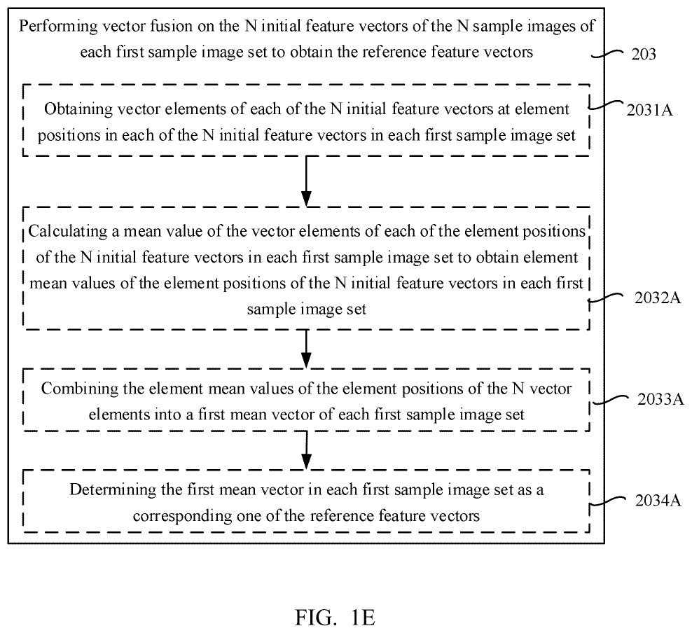

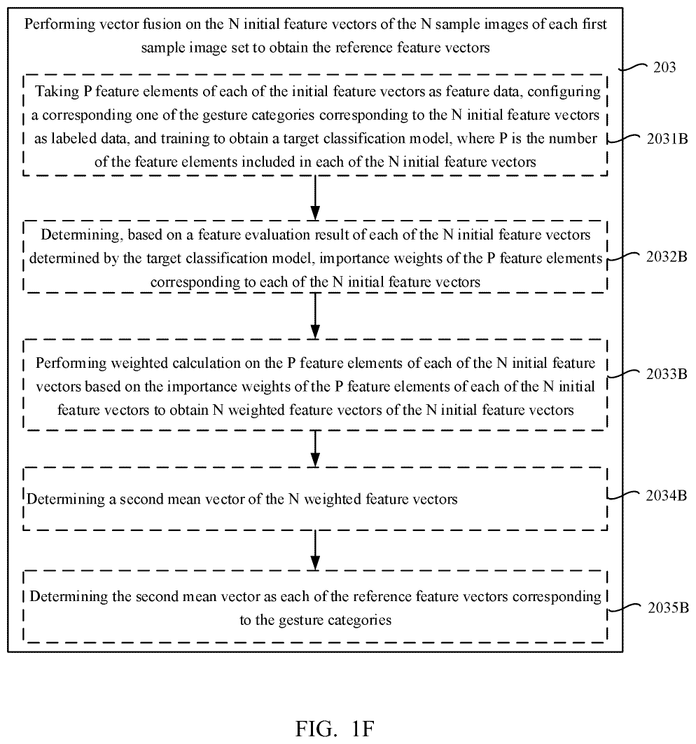

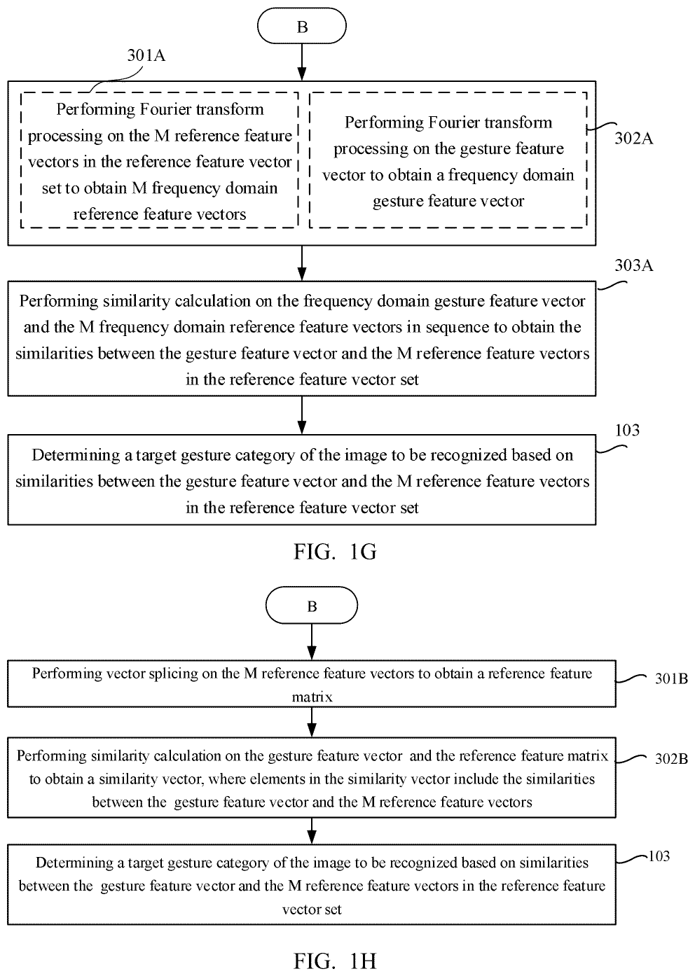

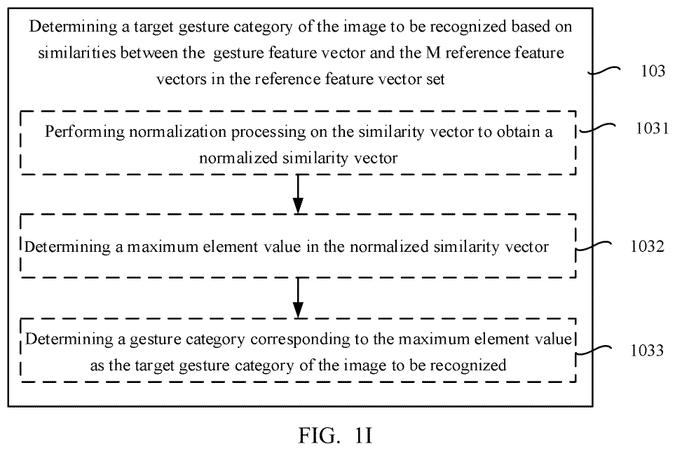

FIG. 1A is a flow chart of a gesture recognition method according to one embodiment of the present disclosure.

As shown in FIG. 1A, the gesture recognition method is executed by an electronic device as an example. The gesture recognition method includes steps 101-103.

The step 101 includes obtaining a reference feature vector set corresponding to an image to be recognized and a gesture category set. The gesture category set is predefined and includes M gesture categories. The reference feature vector set includes M reference feature vectors corresponding to the M gesture categories. Each of the reference feature vectors is obtained by performing vector fusion on initial feature vectors of N sample images of each of the gesture categories. Each of the initial feature vectors is obtained by performing hand feature extraction on each of the sample images. M and N are integers greater than 1.

In some embodiments, the image to be recognized is an image containing a gesture that currently needs to be recognized in the gesture categories. The image to be recognized may be a still photo or a certain frame in a series of video frames. The gesture category set includes the gesture categories that are predetermined, which represent different hand movements or postures, such as clenching a fist, stretching out an index finger, giving a thumb up, etc. The reference feature vector set is a set of the reference feature vectors corresponding to the gesture category set. The reference feature vector set includes the reference feature vectors one-to-one corresponding to the gesture categories in the gesture category set that is predefined. The reference feature vector is the feature vector associated with the gesture category. Any reference feature vector is obtained by fusing the initial feature vectors of multiple sample images under a specific gesture category.

The reference feature vectors are feature vectors associated with the gesture categories. Each of the reference feature vectors is obtained by fusing initial feature vectors of corresponding sample images under a specific gesture category. Each of the initial feature vectors is a feature vector extracted from a corresponding one of the sample images. The sample images are images configured to construct the reference feature vectors. Each of the gesture categories includes sample images, and the sample images thereof include different states of a corresponding one of the gesture categories, such as the same gesture under different angles, different lighting conditions, and different hand colors. M represents the number of all of the gesture categories. N represents the number of the sample images under any one of the gesture categories. The number of the sample images under different gesture categories may be the same or different. M and N are the integers greater than 1.

For example, in a human-computer interactive game scenario (such as wearing a virtual reality (VR) helmet to play a game), it is necessary to recognize the target gesture category of the user to control a character in the game or perform specific game actions. When executing the step 101, a current image of a hand region of the user is captured by a built-in camera of the VR helmet, and the current image is defined as the image to be recognized. Then, the gesture category set that is predefined is loaded, and the gesture category set includes the gesture categories that are predetermined in the game. For example, a gesture of clenching a first means to control the character to attack, a gesture of stretching out an index finger means to point to a specific direction, a gesture of giving a thumbs up means to confirm a current operation, etc. After that, for each of the gesture categories in the gesture category set, a corresponding one of the reference feature vectors that is pre-stored is available. Each of the reference feature vectors is obtained by extracting corresponding initial feature vectors from corresponding sample images under each of the gesture categories and performing vector fusion of the corresponding initial feature vectors. Then, the target gesture category of the user is recognized for playing the game through subsequent steps. In the embodiment, M represents the total number of all game gesture categories. Assuming there are 10 different gesture actions, M=10. N represents the number of the sample images under any one of the gesture categories. For example, when there are 50 sample images under one of the gesture categories, N=50.

For example, in a smart home control scenario, the user is able to control household appliances such as lights, a TV, and a speaker through specific gestures. When executing the step 101, the current image of the hand region of the user is captured through a camera, and the current image is defined as the image to be recognized. Then, the gesture category set that is predefined is loaded. The gesture category set includes the gesture categories that are predetermined for controlling the household appliances. For example, the gesture of clenching the first means to turn off the lights, the gesture of stretching out the index finger means to turn off the speaker, the gesture of giving the thumbs up means to confirm a current operation, etc. After that, for each of the gesture categories in the gesture category set, the corresponding one of the reference feature vectors that is pre-stored is obtained. Each of the reference feature vectors is obtained by extracting the corresponding initial feature vectors from the corresponding sample images under each of the gesture categories and performing vector fusion on the corresponding initial feature vectors. Then, the target gesture category of the user is recognized, thereby realizing intelligent control of the household appliances.

For example, in an educational assistance scenario, a teacher is able to control the playback, switching, and operation of PowerPoints (PPTs) through specific gestures. When executing the step 101, a current image of a hand region of the teacher is captured through a camera, and the current image is defined as the image to be recognized. Then, the gesture category set that is predefined is loaded. The gesture category set includes the gesture categories that are predetermined. For example, the gesture of clenching the first means to pause a current presentation, a gesture of stretching out the index finger and the middle finger means to switch the current presentation to a full screen, and a gesture of putting five fingers together means to continue the presentation. After that, for each of the gesture categories in the gesture category set, the corresponding one of the reference feature vectors that is pre-stored is obtained. Each of the reference feature vectors is obtained by extracting the corresponding initial feature vectors from the corresponding sample images under each of the gesture categories and performing vector fusion on the corresponding initial feature vectors. Then, the target gesture category of the user is recognized, thereby realizing control of the PPTs.

For example, in a drone operation scenario, an operator is able to control takeoff, landing, and a flight path of a drone through specific gestures. When executing the step 101, a current image of a hand region of the operator is captured through a camera of the drone, and the current image is defined as the image to be recognized. Then, the gesture category set that is predefined is loaded. The gesture category set includes the gesture categories that are predetermined. For example, the gesture of clenching the first means to land the drone, the gesture of stretching out the index finger means to control the drone to take off, etc. After that, for each of the gesture categories in the gesture category set, the corresponding one of the reference feature vectors that is pre-stored is obtained. Each of the reference feature vectors is obtained by extracting the corresponding initial feature vectors from the corresponding sample images under each of the gesture categories and performing vector fusion on the corresponding initial feature vectors. Finally, the target gesture category of the operator is recognized through the subsequent steps to realize intelligent control of the drone.

For example, in an intelligent vehicle control scenario, a driver is able to control the acceleration, deceleration and steering of a vehicle through specific gestures. When executing the step 101, a current image of a hand region of the driver is captured through a camera of the vehicle, and the current image is defined as the image to be recognized. Then, the gesture category set that is predefined is loaded. The gesture category set includes the gesture categories that are predetermined. For example, the gesture of clenching the first means to slow down the vehicle, the gesture of stretching out the index finger means to speed up the vehicle, the gesture of giving the thumbs up means to open a sunroof of the vehicle, etc. After that, for each of the gesture categories in the gesture category set, the corresponding one of the reference feature vectors that is pre-stored is obtained. Each of the reference feature vectors is obtained by extracting the corresponding initial feature vectors from the corresponding sample images under each of the gesture categories and performing vector fusion on the corresponding initial feature vectors. Finally, the target gesture category of the driver is recognized through the subsequent steps to realize intelligent control of the vehicle.

For example, in a scenario of intelligent medical diagnosis, a doctor is able to control the zooming in, zooming out, and rotation of medical images through specific gestures. When executing the step 101, a current image of a hand region of the doctor is captured through a camera in an operating room, and the current image is defined as the image to be recognized. Then, the gesture category set that is predefined is loaded. The gesture category set includes the gesture categories that are predetermined. For example, a gesture of opening five fingers means to zoom in on a current medical image, the gesture of clenching the first means to zoom out on the current medical image, the gesture of giving the thumbs up means to rotate the current medical image, etc. After that, for each of the gesture categories in the gesture category set, the corresponding one of the reference feature vectors that is pre-stored is obtained. Each of the reference feature vectors is obtained by extracting the corresponding initial feature vectors from the corresponding sample images under each of the gesture categories and performing vector fusion on the corresponding initial feature vectors. Finally, the target gesture category of the doctor is recognized through the subsequent steps to realize intelligent control of the medical images.

For example, in a smart fitness scenario, an exerciser is able to control the start, stop, and adjustment of a fitness device through specific gestures. When executing the step 101, a current image of a hand region of the exerciser is captured through a built-in camera of the fitness device, and the current image is defined as the image to be recognized. Then, the gesture category set that is predefined is loaded. The gesture category set includes the gesture categories that are predetermined. For example, the gesture of clenching the first means to turn on the fitness device, the gesture of stretching out the index finger means to turn off the fitness device, the gesture of giving the thumbs up means to adjust a gear of the fitness device, etc. After that, for each of the gesture categories in the gesture category set, the corresponding one of the reference feature vectors that is pre-stored is obtained. Each of the reference feature vectors is obtained by extracting the corresponding initial feature vectors from the corresponding sample images under each of the gesture categories and performing vector fusion on the corresponding initial feature vectors. Finally, the target gesture category of the exerciser is recognized through the subsequent steps to realize intelligent control of the fitness device.

For example, in a scenario of intelligent security monitoring, a security guard is able to control the switching, zooming in and out of a monitoring screen through specific gestures. When executing the step 101, a current image of a hand region of the security guard is captured through a built-in camera of a monitoring device, and the current image is defined as the image to be recognized. Then, the gesture category set that is predefined is loaded. The gesture category set includes the gesture categories that are predetermined. For example, the gesture of stretching out the index finger means to switch to a next monitoring screen, the gesture of opening the five fingers means to zoom in on a current monitoring screen, the gesture of clenching the first means to zoom out the current monitoring screen, etc. After that, for each of the gesture categories in the gesture category set, the corresponding one of the reference feature vectors that is pre-stored is obtained. Each of the reference feature vectors is obtained by extracting the corresponding initial feature vectors from the corresponding sample images under each of the gesture categories and performing vector fusion on the corresponding initial feature vectors. Finally, the target gesture category of the security guard is recognized through the subsequent steps to realize intelligent control of the monitoring screen.

The step 102 includes performing hand feature extraction on the image to be recognized to obtain a gesture feature vector.

In some embodiments, the hand feature extraction is a process of extracting the gesture feature vector that is related to gesture recognition from the image to be recognized. The process is configured to extract the gesture feature vector that helps to distinguish different gestures. The hand feature extraction of obtaining the gesture feature vector is the same as the hand feature extraction of obtaining the initial feature vectors in terms of implementation. The gesture feature vector is an output result of the hand feature extraction process. The gesture feature vector is a numerical vector containing all relevant features extracted from the image to be recognized, and each of elements in the gesture feature vector represents a specific attribute or a feature of the gesture in the image to be recognized.

As shown in FIG. 1B, the step 102 shown in FIG. 1A is realized by executing steps 1021-1022.

The step 1021 includes performing hand object detection on the image to be recognized to obtain a to-be-recognized hand object region corresponding to the image to be recognized.

In some embodiments, the hand object detection refers to a process of recognizing and locating a hand in the image to be recognized by using the computer vision technology. A purpose of the hand object detection is to determine which region in the image to be recognized contains the hand, and to output coordinates of two diagonal points of abounding rectangle framing the hand region. The hand object detection adopts an object detection model, such as the object detection model based on conventional image processing technology or deep learning technology, to accurately recognize and locate the hand. Even in complex backgrounds or under different lighting conditions, the object detection model is able to effectively extract the hand region. The hand object region to be recognized is an output result of the hand object detection on the image to be recognized, and the hand object region to be recognized is the region in the image to be recognized that is determined to be the hand after detection.

Through the step 1021, the hand object region is accurately separated from the image to be recognized, eliminating the interference of the background and other objects, providing more accurate input data for a subsequent extraction of the initial feature vector, which reduces the computational complexity and improves the accuracy of gesture recognition.

The step 1022 includes calling a feature extraction unit of a pre-trained image classification model, and performing feature extraction on a local image to be recognized corresponding to the to-be-recognized hand object region to obtain the gesture feature vector. The pre-trained image classification model is obtained by training the second sample image set with classification labels, and the feature extraction unit is a backbone network unit that completes network parameter adjustment by a back propagation algorithm in a training process of the pre-trained image classification model.

In some embodiments, the pre-trained image classification model is a pre-trained deep learning model configured for classifying images. The feature extraction unit is the backbone network unit (the main network structure in the pre-trained image classification model) in the pre-trained image classification model that is responsible for extracting feature vectors from input images. The feature extraction unit may be a network unit composed of convolutional layers, pooling layers and other layers. The feature extraction unit is able to automatically learn and extract high-level features of the input images and characterize the high-level features through feature vectors. The local image to be recognized is a cropped image corresponding to the to-be-recognized hand object region obtained by performing hand object detection in the step 1021. An image data set configured to train the pre-trained image classification model is the second sample image set with classification labels, and each of the sample images in the second sample image set with classification labels has a corresponding one of classification labels, and the sample images in the second sample image set may include other objects that are not limited to hands.

Through the step 1022, the feature extraction unit of the pre-trained image classification model is called to accurately extract key feature information of the hand from the gesture feature vector. Further, since the pre-trained image classification model is trained on the second sample image set with a large amount of classification labels, the pre-trained image classification model is not limited by the number of images containing hands during a training process, and the feature extraction unit has good generalization ability, is able to adapt to different types of images, and is able to accurately extract feature information of the images.

Next, as shown in FIG. 1A, the step 103 is described.

The step 103 includes determining a target gesture category of the image to be recognized based on similarities between the gesture feature vector and the M reference feature vectors in the reference feature vector set.

In some embodiments, a similarity is a quantitative indicator that describes a degree of closeness between the gesture feature vector and one of the reference feature vectors. The greater the similarity, the more similar the gesture feature vector is to the one of the reference feature vectors in terms of features. Namely, the gesture in the image to be recognized and the gesture corresponding to the one of the reference feature vectors are more likely to belong to the same one of the gesture categories. During an execution process, the similarities are determined by calculating the Euclidean distance, cosine similarity, or Manhattan distance. All of the similarities are sorted, a maximum similarity is selected, and then the target gesture category to which the gesture in the image to be recognized belongs is determined based on the corresponding one of the reference feature vectors that matches the maximum similarity. In order to improve the accuracy of gesture recognition, a similarity threshold is provided. Only when the maximum similarity exceeds the similarity threshold, the gesture category corresponding to the corresponding one of the reference feature vectors that matches the maximum similarity is determined as an effective target gesture category.

In the steps 101-103, the similarities between the gesture feature vector of the image to be recognized and the M reference feature vectors are calculated, the gesture feature of the image to be recognized is compared with the gesture category features that are predefined to realize the gesture recognition. Each of the gesture category features is obtained by performing feature extraction and fusing of sample images corresponding to a specific gesture. Therefore, the calculation complexity when determining the target gesture category of the image to be recognized is reduced, and the gesture recognition efficiency is effectively improved.

In some embodiments, as shown in FIG. 1C (where A represents steps 101-103), before the step 101, the reference feature vectors in the step 101 may be acquired through steps 201-203, which are described in detail below.

The step 201 includes obtaining a first sample image set of each of the gesture categories in the gesture category set, where each first sample image set includes the N sample images of each of the gesture categories.

In some embodiments, the first sample image set is a sample image set collected for each of the gesture categories in the gesture category set, and each of the gesture categories includes a corresponding first sample image set.

The step 202 includes performing hand feature extraction on the N sample images of each first sample image set to obtain the N initial feature vectors of the N sample images of each first sample image set.

In some embodiments, the initial feature vectors are feature vectors extracted from the sample images of the gesture categories. Each of the initial feature vectors is a result of the hand feature extraction for each of the sample images. The initial feature vectors map key features of the gestures, such as hand shapes, postures, key point positions, etc.

In some embodiments, as shown in FIG. 1D, the step 202 shown in FIG. 1C is realized through steps 2021-2023, which are described in detail below.

The step 2021 includes performing hand object detection on the N sample images of each of the gesture categories to obtain N hand object regions corresponding to the N sample images of each of the gesture categories.

In some embodiments, one of the gesture categories is taken as an example for illustration. The N sample images under the one of the gesture categories are loaded, and a trained hand object detection algorithm is applied to perform the hand object detection on each of the sample images to obtain the N hand object regions corresponding to the N sample images, and the N hand object regions are one-to-one corresponding to the N sample images. The trained hand object detection algorithm is the deep learning method (such as a convolutional neural network) or the conventional image processing technology (such as edge detection, color segmentation, etc.).

The step 2022 includes cropping the N hand object regions from the N sample images of each of the gesture categories to obtain local images.

In some embodiments, the N sample images are traversed, and for each of the sample images traversed, a cropping starting point and a cropping size thereof are determined according to a position and a size of a corresponding hand object region. Then, the image processing technology, such as pixel-level cropping or region replication, is adopted to crop a local image containing only a corresponding one of the hand object regions from each of the sample images. The local image of each of the sample images is the local image corresponding to each of the hand object regions. Finally, N local images are obtained. Each of the N hand object regions has a corresponding one of the N local images. Namely, the local images are one-to-one corresponding to the hand object regions.

The step 2023 includes performing feature extraction on the local images corresponding to the N hand object regions to obtain the N initial feature vectors of the N sample images of each first sample image set.

In some embodiments, feature extraction is performed on the local images corresponding to the N hand object regions obtained in the step 2022 by methods such as scale-invariant feature transform (SIFT), speeded-up robust features (SURF), histograms of oriented gradients (HOG), local binary patterns (LBP), ResNet or DenseNet, and non-vector extraction results are vectorized to finally obtain the N initial feature vectors. The N initial feature vectors are one-to-one corresponding to the local images that are one-to-one corresponding to the hand object regions.

Through the steps 2021-2023, descriptive and distinguishing features of the hand are automatically extracted from the sample images and represented as the initial feature vectors in a form of numerical vectors. The initial feature vectors are capable of effectively capturing changes of the hand in different postures, shapes, textures, etc., and provide strong data support for subsequent gesture recognition.

Next, as shown in FIG. 1C, the step 203 is described in detail below.

The step 203 includes performing vector fusion on the N initial feature vectors of the N sample images of each first sample image set to obtain the reference feature vectors.

In some embodiments, as shown in FIG. 1E, the step 203 shown in FIG. 1C are realized through steps 2031A-2034A, which are described in detail below.

The step 2031A includes obtaining vector elements of each of the N initial feature vectors at element positions in each of the N initial feature vectors in each first sample image set.

In some embodiments, the element positions of each of the initial feature vectors are traversed, and at each of the element positions, corresponding vector elements of the initial feature vectors are selected.

For example, when N is 2, and the two initial feature vectors are [1, 3, 6, 8] and [2, 4, 8, 10]. Then the elements of a first element position of the two initial feature vectors are 1 and 2, the elements of a second element position of the two initial feature vectors are 3 and 4. The other elements are obtained similarly, which is not depicted in detail herein.

The step 2032A includes calculating a mean value of the vector elements of each of the element positions of the N initial feature vectors in each first sample image set to obtain element mean values of the element positions of the N initial feature vectors in each first sample image set.

In some embodiments, taking one first sample image set as an example for illustration. The vector elements of each of the element positions of the N initial feature vectors obtained in step 2031A are arithmetic averaged to obtain the mean value of the vector elements of each of the element positions of the N initial feature vectors.

For example, when N is 2, the two initial feature vectors are [1, 3, 6, 8] and [2, 4, 8, 10], then the element mean value of the first element position of the two initial feature vectors is 1.5, the element mean value of the second element position of the two initial feature vectors is 3.5, and so on.

The step 2033A includes combining the element mean values of the element positions of the N vector elements into a first mean vector of each first sample image set.

In some embodiments, taking one first sample image set as an example for illustration. The element mean values of the element positions are arranged according to an order of the element positions of the initial feature vectors to form a new vector, which is the first mean vector. The first mean vector is obtained by calculating the element mean values of the N initial feature vectors.

For example, when the initial feature vectors are [1, 3, 6, 8] and [2, 4, 8, 10], then the first mean vector is [1.5, 3.5, 7, 9].

The step 2034A includes determining the first mean vector in each first sample image set as a corresponding one of the reference feature vectors.

Through the steps 2031A-2034A, taking one first sample image set as an example for illustration. The first mean vector formed by the element mean values of the initial feature vectors of the sample images is configured as one of the reference feature vectors, which simplifies the feature fusion process and ensures representativeness of the one of the reference feature vectors of the specific gesture category.

In some embodiments, as shown in FIG. 1F, the step 203 shown in FIG. 1C is also allowed to be implemented through steps 2031B-2035B, which are described in detail below.

The step 2031B includes taking P feature elements of each of the initial feature vectors as feature data, configuring a corresponding one of the gesture categories corresponding to the N initial feature vectors as labeled data, and training to obtain a target classification model, where P is the number of the feature elements included in each of the N initial feature vectors.

In some embodiments, different feature elements represent different feature information such as the shape of the hand, a specific pattern of the gesture, and the key point positions. The feature elements are an important basis for distinguishing different gesture categories. In the step, the N initial feature vectors are traversed, and the P feature elements included in each of the initial feature vectors are extracted. The feature elements are served as input data (i.e., the feature data) provided to the target classification model. At the same time, a corresponding one of the gesture categories corresponding to a current initial feature vector is obtained, and the corresponding one of the gesture categories is configured as the labeled data. Then, based on the feature data and the labeled data, the target classification model (such as a decision tree, a random forest or a support vector machine, etc.) is trained.

The step 2032B includes determining, based on a feature evaluation result of each of the N initial feature vectors determined by the target classification model, importance weights of the P feature elements corresponding to each of the N initial feature vectors. The feature evaluation result is a data processing result obtained by evaluating a feature importance degree of each of the N initial feature vectors in a classification process of the target classification model.

In some embodiments, the feature evaluation result is the result obtained after the target classification model evaluates the P feature elements of each of the initial feature vectors during the classification process when the target classification model is trained. The feature evaluation result reflects an importance degree of each of the feature elements in distinguishing different gesture categories in the classification process when the target classification model is trained. The importance weights of the feature elements are weights respectively assigned to the P feature elements of each of the initial feature vectors based on the feature evaluation result. The importance weights reflect the importance degree of the feature elements in distinguishing the gesture categories processed by the target classification model. The greater an importance weight of one of the feature elements, the more important the one of the feature elements is in the classification process, and the greater the impact on the feature evaluation result of the target classification model.

For example, when the decision tree is configured as the target classification model, the importance of the feature evaluation result determined by the target classification model is measured by calculating the number of times different feature elements appear as splitting basis in all tree nodes (number of splits). Alternatively, the importance of different feature elements is measured by information gain (information gain can measure the change in data purity before and after splitting), or by Gini index (the Gini index is configured to evaluate the splitting quality of feature elements). Then, an importance evaluation of the P feature elements by the feature evaluation result is quantified to obtain the importance weights of the feature element.

Through the step 2032B, the importance weights are respectively assigned to the feature elements in the initial feature vectors, and it is determined which feature elements are more important to a classification result, thereby guiding the subsequent steps to perform feature selection or optimization. Thus, in the subsequent steps, more attention is paid to the feature elements that have a greater impact on the classification results, thereby improving the accuracy and efficiency of classification.

The step 2033B includes performing weighted calculation on the P feature elements of each of the N initial feature vectors based on the importance weights of the P feature elements of each of the N initial feature vectors to obtain N weighted feature vectors of the N initial feature vectors.

In some embodiments, the feature elements of the initial feature vectors are adjusted according to the importance weights of the feature elements to obtain the weighted feature vectors. Each of feature element values in each of the weighted feature vectors is a result adjusted according to an importance weight thereof.

Through the step 2033B, the weighted feature vectors obtained not only retain information of the initial feature vectors, but also, by introducing the importance weights, make key features receive more attention. Further, the weighted feature vectors more accurately reflect intrinsic feature distribution and importance of the feature data, thereby improving performance of subsequent classification tasks.

The step 2034B includes determining a second mean vector of the N weighted feature vectors.

In some embodiments, the second mean vector is a new feature vector obtained by performing mean calculation on N weighted feature vectors.

The step 2035B includes determining the second mean vector as each of the reference feature vectors corresponding to the gesture categories.

Through the steps 2031B-2035B, the target classification model is configured to evaluate the influence of each of the feature elements in each of the initial feature vectors on the classification result, and then the feature elements in each of the initial feature vectors are weighted one by one based on corresponding importance weights. Then, a mean vector is calculated to obtain the second mean vector configured as one of the reference feature vectors. Therefore, the reference feature vectors are capable of improving the discrimination of different gesture feature vectors and more accurately reflecting different gestures, thereby improving the accuracy of the gesture recognition.

In some embodiments, as shown in FIG. 1G (where B represents the steps 101-102), before the step 103 shown in FIG. 1A, the similarities between the gesture feature vector and the M reference feature vectors in the reference feature vector set are obtained through steps 301A-303A, which are described in detail below.

The step 301A includes performing Fourier transform on the M reference feature vectors in the reference feature vector set to obtain M frequency domain reference feature vectors.

In some embodiments, the frequency domain reference feature vectors are obtained by Fourier transforming the reference feature vectors. Each of the frequency domain reference feature vectors includes distribution information of corresponding gesture features at different frequencies.

The step 302A includes performing Fourier transform on the gesture feature vector to obtain a frequency domain gesture feature vector.

In some embodiments, the frequency domain gesture feature vector refers to a vector obtained by Fourier transforming the gesture feature vector. The frequency domain gesture feature vector includes distribution information of gesture features in the image to be recognized at different frequencies.

The step 303A includes performing similarity calculation on the frequency domain gesture feature vector and the M frequency domain reference feature vectors in sequence to obtain the similarities between the gesture feature vector and the M reference feature vectors in the reference feature vector set.

In some embodiments, each of the similarities is determined by calculating a cosine similarity, a Euclidean distance, a Manhattan distance, a Pearson correlation coefficient, or a Jaccard similarity coefficient between the frequency domain gesture feature vector and each of the frequency domain reference feature vectors. By calculating the similarities between the gesture feature vector and the M reference feature vectors in sequence, M similarities are obtained, and the M similarities are determined as the similarities between the gesture feature vector and the M reference feature vectors in the reference feature vector set.

Through the steps 301A-303A, feature representations of the gesture feature vector and the M reference feature vectors are converted from a spatial domain to a frequency domain by performing the Fourier transform. In the frequency domain, periodic characteristics of signals are more obvious, and spectral characteristics of different gestures are more effectively captured and compared, which improves the anti-interference ability and sensitivity to subtle movement changes of the gesture recognition method of the embodiment of the present disclosure, thereby improving the accuracy of the gesture recognition.

In some embodiments, as shown in FIG. 1H (where B represents the steps 101-102), before the step 103 shown in FIG. 1A, the similarities between the gesture feature vector and the M reference feature vectors in the reference feature vector set are obtained through steps 301B-302B, which are described in detail below.

The step 301B includes performing vector splicing on the M reference feature vectors to obtain a reference feature matrix.

In some embodiments, lengths of the M reference feature vectors are the same, and the M reference feature vectors are spliced into the reference feature matrix by horizontal splicing (i.e., splicing by column) or vertical splicing (i.e., splicing by row). The reference feature matrix contains feature vector information of all of the gesture categories. In a vertically spliced reference feature matrix, each row represents a corresponding one of the reference feature vectors, and each column represents a corresponding feature dimension in the corresponding one of the reference feature vectors,

Through the step 301B, the reference feature vectors are spliced into the reference feature matrix, which realizes the integration and unified representation of the reference feature vectors and facilitates subsequent unified processing and analysis.

The step 302B includes performing similarity calculation on the gesture feature vector and the reference feature matrix to obtain a similarity vector, where elements in the similarity vector include the similarities between the gesture feature vector and the M reference feature vectors.

In some embodiments, the gesture feature vector and feature elements of each row in the reference feature matrix are extracted to calculate the similarities between the gesture feature vector and the reference feature matrix. Similarity values obtained after the calculation form the similarity vector. Each of the elements in the similarity vector represents a corresponding one of the similarities between the gesture feature vector and the feature elements of a corresponding row (the corresponding one of the reference feature vectors) in the reference feature matrix.

Through the steps 301B-302B, a problem that the similarity calculation between the gesture feature vector and the reference feature vectors may involve discontinuous memory access is avoided. Specifically, when the reference feature vectors are not stored continuously and need to be accessed by jumping in the calculation, more cache misses are caused, which reduce the performance of gesture recognition. In the embodiment, the similarity calculation between the reference feature matrix and the gesture feature vector reduces the cache misses and improves the calculation efficiency of the gesture recognition.

In some embodiments, each of the elements in the similarity vector obtained through the steps 301B-302B corresponds to the corresponding one of the gesture categories. As shown in FIG. 1I, the step 103 in FIG. 1A is implemented through steps 1031-1033, which are described in detail below.

The step 1031 includes performing normalization processing on the similarity vector to obtain a normalized similarity vector.

In some embodiments, any normalization method is allowed to be applied to transform the elements in the similarity vector to ensure that a sum of absolute values of elements in a transformed similarity vector (i.e., the normalized similarity vector) or a sum of squares of the elements in the transformed similarity vector is equal to 1. The normalization method used in the embodiment of the present disclosure may be a minimum absolute value normalization method, a Euclidean normalization method, a maximum value normalization method, a minimum-maximum normalization method, an interval scaling normalization method, or a zero mean normalization method.

For example, when the similarity vector is [0.8, 0.6, 0.2, 0.4, 0.1], then after the similarity vector is subjected to minimum-maximum normalization, the normalized similarity vector obtained is [1.0, 0.714, 0.143, 0.429, 0.0].

Through the step 1031, the normalized similarity vector with a uniform scale is obtained, which eliminates scale differences that may exist in the similarity vector, thereby making subsequent comparison and analysis more accurate and reliable.

The step 1032 includes determining a maximum element value in the normalized similarity vector.

In some embodiments, all of the elements in the normalized similarity vector are traversed, and the element values of the elements in the normalized similarity vector are compared one by one. During a traversal process, a current maximum element value is found, recorded, and updated. When the traversal process is completed, the maximum element value and a corresponding element index are output.

The step 1033 includes determining a gesture category corresponding to the maximum element value as the target gesture category of the image to be recognized.

In some embodiments, the gesture category corresponding to the maximum element value is determined according to the element index of the maximum element value, and the gesture category corresponding to the maximum element value is output as the target gesture category of the image to be recognized.

Through the steps 1031-1033, the target gesture category of the image to be recognized is accurately matched with the maximum element value in the normalized similarity vector, thereby improving the accuracy and efficiency of the gesture recognition.

The following is an explanation of an exemplary application of one embodiment of the present disclosure in a practical application scenario.

The embodiments of the present disclosure further provide a gesture recognition model. The core concept of the embodiments of the present disclosure is the gesture recognition model with high recognition ability can be quickly trained based on a small number of sample images, and the gesture recognition model is able to be used in machine learning application development scenarios such as human-computer interaction and educational demonstration. In a training stage, the gesture recognition model uses the object detection model that has been trained with a hand detection data set and an image classification model that has been trained (i.e., the pre-trained image classification model) with a gesture classification data set as a hand detection and hand feature extraction model, and then extracts the initial feature vectors of each of the gesture categories from a current training set including a small number of sample images, and then processes to obtain the reference feature vector matrix containing the gesture categories. In an inference stage of the gesture recognition model, the hand detection and hand feature extraction model is configured to extract the gesture feature vector of the image to be recognized, and then the similarities between the gesture feature vector and the reference feature vectors corresponding to the gesture categories are calculated to obtain the similarity vector, and the similarity vector is normalized to obtain a category prediction vector of the image to be recognized (i.e., the normalized similarity vector), and the gesture category with the maximum prediction probability in the category prediction vector is selected as a prediction result of the gesture recognition model.

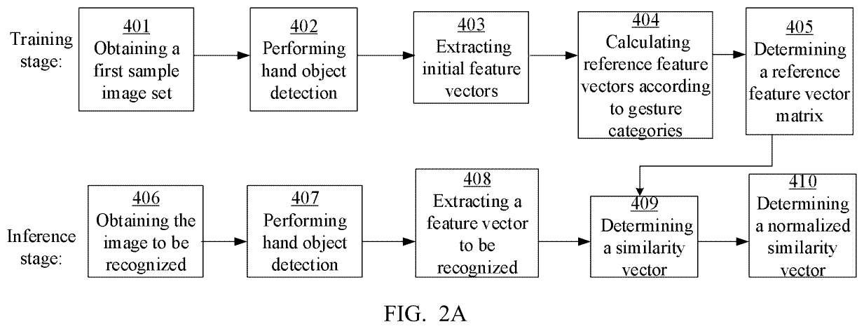

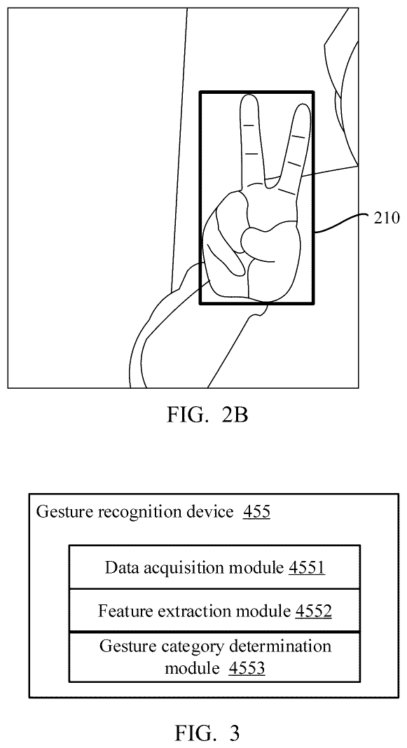

As shown in FIG. 2A, the training stage and the inference stage of the gesture recognition model in the embodiments of the present disclosure are implemented through steps 401-410, which are described in detail below.

The step 401 includes obtaining the first sample image set.

In the step 401, the gesture categories to be classified are determined first, then the sample images corresponding to each of the gesture categories are obtained. The number of the sample images does not need to be too many, but to ensure the classification effect, each of the gesture categories should have no less than 2 sample images, and different sample images in the same one of the gesture categories should have different hand postures when collected, so as to improve richness of the sample images. Each of the sample images should contain a gesture, and a collection of the sample images corresponding to the gesture categories is determined as the first sample image set.

The step 402 includes performing hand object detection.

In the step 402, the object detection model is trained by using the first sample image set to extract the hand object region in each of the sample images to obtain the local images. The hand object region in each of the local images refers to the minimum circumscribed rectangle of the hand region in each of the sample images. As shown in the thick rectangular box in FIG. 2B, the first sample image set should include as many possible gesture categories as possible, and the hands in the sample images should include various postures and under various lighting conditions. The hand detection model of the embodiments of the present disclosure may be the object detection model in the related art, such as a yolov6 model and a Single Shot MultiBox Detector (SSD).

The step 403 includes extracting initial feature vectors.

In the step 403, the image classification model (i.e., the pre-trained image classification mode mentioned above) is trained by the local images to extract the features of each of the local images. The features of each of the local images refer to each of the initial feature vectors calculated based on each of the local images. The initial feature vectors of the local images reflect the features of the gesture in each of the local images. When training the image classification model, as many gestures categories as possible are covered, so that the features extracted have the best classification effect. After the training is completed, only the feature extraction part (i.e., the backbone network part) of the image classification model is retained for feature extraction. The image classification model is a lightweight deep learning model, such as a Mobilenetv2 model or a ShuffleNet model.

The sample images to be processed are input into the object detection model, and the object detection model outputs one or more hand detection results, retains the hand region with the highest confidence, and uses the bounding box information output by the object detection model (i.e., the coordinates of the upper left corner and lower right corner of the rectangular frame 210 in FIG. 2B) to obtain the hand object region in each of the sample images. Each hand object region is cropped and input into the feature extraction unit (the feature extraction portion of the image classification model), and a one-dimensional vector output by the feature extraction unit is the initial feature vector of each of the sample images.

The step 404 includes calculating the reference feature vectors according to the gesture categories.

In the step 404, for each of the gesture categories, a mean value or a weighted mean value of the initial feature vectors of all sample images of each of the gesture categories is calculated to obtain each of the reference feature vectors.

The step 405 includes determining the reference feature vector matrix.

In the step 405, for a scene with X gesture categories, X reference feature vectors are finally obtained to form an X-dimensional reference feature vector matrix. The X-dimensional reference feature vector matrix is used in the subsequent gesture classification and recognition process.

The step 406 includes obtaining the image to be recognized.

In the step 406, firstly, the image to be recognized is obtained, and the image to be recognized includes a hand region of the target gesture category to be recognized.

The step 407 includes performing the hand object detection on the image to be recognized.

The step 407 is similar to the step 402. The position of the hand region is detected in the image to be recognized, which is achieved by using the object detection algorithm.

The step 408 includes extracting the gesture feature vector.

Once the hand region of the image to be recognized is detected, the gesture feature vector is extracted from the hand region. The step 408 is similar to the step 403, but in the step, the gesture recognition model is trained. The step 409 includes determining the similarity vector.

In the step 409, the similarities between the gesture feature vector and the reference feature vectors are calculated in the X-dimensional reference feature vector matrix to obtain a 1*X-dimensional similarity vector. The similarity calculation in the embodiments of the present disclosure adopts the cosine similarity calculation method.

The step 410 includes determining the normalized similarity vector.

In the step 410, the similarity vector is normalized to obtain the normalized similarity vector. The elements in the normalized similarity vector represent the similarities between the gesture to be recognized and the gestures of the gesture category. By comparing the element values in the normalized similarity vector, the target gesture category is determined. Each of the elements in the normalized similarity vector is approximately considered as a predicted probability value after predicting a corresponding one of the gesture categories. The vector normalization calculation process is implemented by the following formula (1):

$${y}_{i} = \frac{{x}_{i}}{{\sum }_{j = 0}^{n} {x}_{j}} \qquad ( 1 )$$

yᵢ is a predicted value of an i-th gesture category, xᵢ is an i-th cosine similarity calculation result, xⱼ is a j-th cosine similarity calculation result, and n is the number of the gesture categories.

The following further describes an exemplary structure of a gesture recognition device 455 in the embodiments of the present disclosure implemented as a software module. As shown in FIG. 3, the gesture recognition device 455 includes a data acquisition module 4551, a feature extraction module 4552, and a gesture category determination module 4553. The data acquisition module 4551 is configured to obtain a reference feature vector set corresponding to an image to be recognized and a gesture category set. The gesture category set is predefined and includes M gesture categories. The reference feature vector set includes M reference feature vectors corresponding to the M gesture categories. Each of the reference feature vectors is obtained by performing vector fusion on initial feature vectors of N sample images of each of the gesture categories. Each of the initial feature vectors is obtained by performing hand feature extraction on each of the sample images. M and N are integers greater than 1. The feature extraction module 4552 is configured to perform hand feature extraction on the image to be recognized to obtain a gesture feature vector. The gesture category determination module 4553 is configured to determine a target gesture category of the image to be recognized based on similarities between the gesture feature vector and the M reference feature vectors in the reference feature vector set.

In some embodiments, the gesture recognition device 455 further includes a reference feature vector generation module. The reference feature vector generation module is configured to obtain a first sample image set of each of the gesture categories in the gesture category set. Each first sample image set includes the N sample images of each of the gesture categories. The reference feature vector generation module is further configured to perform hand feature extraction on the N sample images of each first sample image set to obtain the N initial feature vectors of the N sample images of each first sample image set. The reference feature vector generation module is further configured to perform vector fusion on the N initial feature vectors of the N sample images of each first sample image set to obtain the reference feature vectors corresponding to the gesture categories.

In some embodiments, the reference feature vector generation module is further configured to perform hand object detection on the N sample images of each of the gesture categories to obtain N hand object regions corresponding to the N sample images of each of the gesture categories. The reference feature vector generation module is further configured to crop the N hand object regions from the N sample images of each of the gesture categories to obtain local images and perform feature extraction on the local images corresponding to the N hand object regions to obtain the N initial feature vectors of the N sample images of each first sample image set.

In some embodiments, the reference feature vector generation module is further configured to obtain vector elements of each of the N initial feature vectors at element positions in each of the N initial feature vectors in each first sample image set. The reference feature vector generation module is further configured to calculate a mean value of the vector elements of each of the element positions of the N initial feature vectors in each first sample image set to obtain element mean values of the element positions of the N initial feature vectors in each first sample image set. The reference feature vector generation module is further configured to combine the element mean values of the element positions of the N vector elements into a first mean vector of each first sample image set. The reference feature vector generation module is further configured to determine the first mean vector in each first sample image set as a corresponding one of the reference feature vectors corresponding to the gesture categories.

In some embodiments, the reference feature vector generation module is further configured to take P feature elements of each of the initial feature vectors as feature data, configure the gesture categories corresponding to the N initial feature vectors as labeled data and train to obtain a target classification model. P is the number of the feature elements included in each of the N initial feature vectors.

The reference feature vector generation module is further configured to determine, based on a feature evaluation result of each of the N initial feature vectors determined by the target classification model, importance weights of the P feature elements corresponding to each of the N initial feature vectors. The feature evaluation result is a data processing result obtained by evaluating a feature importance degree of each of the N initial feature vectors in a classification process of the target classification model.

The reference feature vector generation module is further configured to perform weighted calculation on the P feature elements of each of the N initial feature vectors based on the importance weights of the P feature elements of each of the N initial feature vectors to obtain N weighted feature vectors of the N initial feature vectors. The reference feature vector generation module is further configured to determine a second mean vector of the N weighted feature vectors and determine the second mean vector as each of the reference feature vectors corresponding to the gesture categories.

In some embodiments, the gesture recognition device 455 further includes a first similarity determination module. The first similarity determination module is configured to perform vector splicing on the M reference feature vectors to obtain a reference feature matrix and perform similarity calculation on the gesture feature vector and the reference feature matrix to obtain a similarity vector. Elements in the similarity vector include the similarities between the gesture feature vector and the M reference feature vectors.

In some embodiments, each of the elements in the similarity vector corresponds to a corresponding one of the gesture categories. The gesture category determination module 4553 is further configured to perform normalization processing on the similarity vector to obtain a normalized similarity vector, determine a maximum element value in the normalized similarity vector, and determine a gesture category corresponding to the maximum element value as the target gesture category of the image to be recognized.

In some embodiments, the gesture recognition device 455 further includes a second similarity determination module. The second similarity determination module is configured to perform Fourier transform on the M reference feature vectors in the reference feature vector set to obtain M frequency domain reference feature vectors, perform Fourier transform on the gesture feature vector to obtain a frequency domain gesture feature vector; and perform similarity calculation on the frequency domain gesture feature vector and the M frequency domain reference feature vectors in sequence to obtain the similarities between the gesture feature vector and the M reference feature vectors in the reference feature vector set.

In some embodiments, the feature extraction module 4552 is further configured to perform hand object detection on the image to be recognized to obtain a to-be-recognized hand object region corresponding to the image to be recognized.

The feature extraction module 4552 is further configured to call a feature extraction unit of a pre-trained image classification model and perform feature extraction on a local image to be recognized corresponding to the to-be-recognized hand object region to obtain the gesture feature vector. The pre-trained image classification model is obtained by training a second sample image set with classification labels. The feature extraction unit is a backbone network unit that completes network parameter adjustment by a back propagation algorithm in a training process of the pre-trained image classification model.

The embodiments of the present disclosure provide a computer program product. The computer program product includes a computer program or computer-executable instructions, and the computer program or the computer-executable instructions are stored in a computer-readable storage medium. The at least one processor of the electronic device reads the computer-executable instructions from the computer-readable storage medium, and the at least one processor executes the computer-executable instructions, so that the electronic device performs the gesture recognition method of the embodiments of the present disclosure.

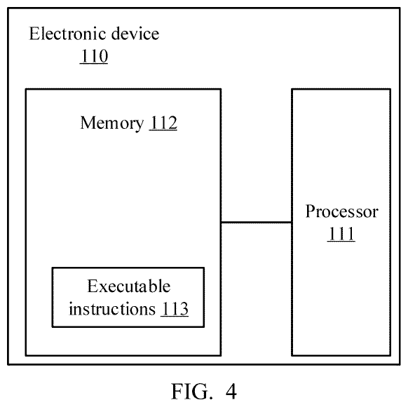

The present disclosure provides an electronic device. FIG. 4 is a block diagram of the electronic device according to one embodiment of the present disclosure. As shown in FIG. 4, the electronic device 110 includes: at least one processor 111 (only one processor is shown in FIG. 4), a memory 112, and executable instructions 113 stored in the memory 112 and executable on the at least one processor 111. When the at least one processor 111 executes the executable instructions 113, the steps in any embodiment of the gesture recognition method are implemented.

The at least one processor 111 may be a central processing unit (CPU), a general-purpose processor, a digital signal processor (DSP), an application-specific integrated circuit (ASIC), a field-programmable gate array (FPG), a programmable logic device, a discrete gate or transistor logic device, a discrete hardware component, etc. The general-purpose processor may be a microprocessor or the at least one processor may be any conventional processor, etc.

In some embodiments, the memory 112 may be an internal storage unit of the electronic device 110, such as a hard disk or the memory of the electronic device 110. In other embodiments, the memory 112 may be an external storage device of the electronic device 110, such as a plug-in hard disk, a smart media card (SMC), a secure digital (SD) card, a flash card, etc. equipped on the electronic device 110. Alternatively, the memory 112 may include both the internal storage unit of the electronic device 110 and the external storage device. The memory 112 is configured to store an operating system, an application program, a boot loader, data, and other programs, such as program codes of a computer program, etc. The memory 112 may be configured to temporarily store data that has been output or is to be output.

The present disclosure provides a computer-readable storage medium. The computer-readable storage medium includes computer-executable instructions stored therein; or a computer program stored therein. The computer-executable instructions or the computer program is executed by the at least one processor to implement the gesture recognition method shown in FIG. 1A.

In some embodiments, the computer-readable storage medium may be the memory such as the RAM, the ROM, the flash memory, a magnetic surface memory, an optical disk, a CD-ROM; or other devices including one or any combination of the above memories.

In some embodiments, the computer-executable instructions are in the form of a program, a software, a software module, a script, or codes, written in any form of programming language (including compiled or interpreted languages, or declarative or procedural languages), and are deployed in any form, including being deployed as an independent program or as a module, a component, a subroutine, or other unit suitable for use in a computing environment.

As an example, the computer-executable instructions may, but not necessarily, correspond to a file in a file system. Instead, the computer-executable instructions are stored as parts of a file storing other programs or data. For instance, the computer-executable instructions are stored in one or more scripts in a hypertext markup language (HTML) document, in a single file dedicated to the program in question, or are stored in multiple collaborative files (e.g., files storing one or more modules, subroutines, or code portions).

As an example, the computer-executable instructions are deployed to be executed on the electronic device, or on a plurality of electronic devices located at one location. Alternatively, the computer-executable instructions are executed on electronic devices disposed at multiple locations and interconnected by a communication network.

In summary, the embodiments of the present disclosure realize the stable conversion of the original image into the target image of the predetermined target style, improves the relevance of the target image to the original image, and does not require manual text input, thereby improving the accuracy and efficiency of the image stylization processing.

The above description is only optional embodiments of the present disclosure and is not intended to limit the protection scope of the present disclosure. Any modifications, equivalent substitutions, improvements, etc. made within the spirit and scope of the present disclosure are included in the protection scope of the present disclosure.

What is claimed is:

1. A gesture recognition method, comprising steps:
obtaining a reference feature vector set corresponding to an image to be recognized and a gesture category set; wherein the gesture category set is predefined and comprises M gesture categories; the reference feature vector set comprises M reference feature vectors corresponding to the M gesture categories, each of the reference feature vectors is obtained by performing vector fusion on initial feature vectors of N sample images of each of the gesture categories, each of the initial feature vectors is obtained by performing hand feature extraction on each of the sample images, and M and N are integers greater than 1;
performing hand feature extraction on the image to be recognized to obtain a gesture feature vector; and
determining a target gesture category of the image to be recognized based on similarities between the gesture feature vector and the M reference feature vectors in the reference feature vector set.

2. The gesture recognition method according to claim 1, wherein before the step of obtaining the reference feature vector set corresponding to the image to be recognized and the gesture category set, the gesture recognition method further comprises steps:
obtaining a first sample image set of each of the gesture categories in the gesture category set, wherein each first sample image set comprises the N sample images of each of the gesture categories;
performing hand feature extraction on the N sample images of each first sample image set to obtain the N initial feature vectors of the N sample images of each first sample image set; and
performing vector fusion on the N initial feature vectors of the N sample images of each first sample image set to obtain the reference feature vectors corresponding to the gesture categories.

3. The gesture recognition method according to claim 2, wherein the step of performing hand feature extraction on the N sample images of each first sample image set to obtain the N initial feature vectors of the N sample images of each first sample image set comprises steps:
performing hand object detection on the N sample images of each of the gesture categories to obtain N hand object regions corresponding to the N sample images of each of the gesture categories;
cropping the N hand object regions from the N sample images of each of the gesture categories to obtain local images; and
performing feature extraction on the local images corresponding to the N hand object regions to obtain the N initial feature vectors of the N sample images of each first sample image set.

4. The gesture recognition method according to claim 2, wherein the step of performing vector fusion on the N initial feature vectors of the N sample images of each first sample image set to obtain the reference feature vectors corresponding to the gesture categories comprises steps:
obtaining vector elements of each of the N initial feature vectors at element positions in each of the N initial feature vectors in each first sample image set;
calculating a mean value of the vector elements of each of the element positions of the N initial feature vectors in each first sample image set to obtain element mean values of the element positions of the N initial feature vectors in each first sample image set;
combining the element mean values of the element positions of the N vector elements into a first mean vector of each first sample image set; and
determining the first mean vector in each first sample image set as a corresponding one of the reference feature vectors corresponding to the gesture categories.

5. The gesture recognition method according to claim 2, wherein the step of performing vector fusion on the N initial feature vectors of the N sample images of each first sample image set to obtain the reference feature vectors comprises steps:
for each of the initial feature vectors, taking P feature elements thereof as feature data, configuring a corresponding one of the gesture categories corresponding to the N initial feature vectors as labeled data, and training to obtain a target classification model, where P is the number of the feature elements included in each of the N initial feature vectors;
determining, based on a feature evaluation result of each of the N initial feature vectors determined by the target classification model, importance weights of the P feature elements corresponding to each of the N initial feature vectors, wherein the feature evaluation result is a data processing result obtained by evaluating a feature importance degree of each of the N initial feature vectors in a classification process of the target classification model;
performing weighted calculation on the P feature elements of each of the N initial feature vectors based on the importance weights of the P feature elements of each of the N initial feature vectors to obtain N weighted feature vectors of the N initial feature vectors,
determining a second mean vector of the N weighted feature vectors; and
determining the second mean vector as a corresponding one of the reference feature vectors.

6. The gesture recognition method according to claim 1, wherein before the step of determining the target gesture category of the image to be recognized based on the similarities between the gesture feature vector and the M reference feature vectors in the reference feature vector set, the gesture recognition method further comprises steps:
performing vector splicing on the M reference feature vectors to obtain a reference feature matrix; and
performing similarity calculation on the gesture feature vector and the reference feature matrix to obtain a similarity vector, where elements in the similarity vector comprise the similarities between the gesture feature vector and the M reference feature vectors.

7. The gesture recognition method according to claim 6, wherein each of the elements in the similarity vector corresponds to a corresponding one of the gesture categories; and the step of determining the target gesture category of the image to be recognized based on the similarities between the gesture feature vector and the M reference feature vectors in the reference feature vector set comprises steps:
performing normalization processing on the similarity vector to obtain a normalized similarity vector;
determining a maximum element value in the normalized similarity vector; and
determining a gesture category corresponding to the maximum element value as the target gesture category of the image to be recognized.

8. The gesture recognition method according to claim 1, wherein before the step of determining the target gesture category of the image to be recognized based on the similarities between the gesture feature vector and the M reference feature vectors in the reference feature vector set, the gesture recognition method further comprises steps:
performing Fourier transform on the M reference feature vectors in the reference feature vector set to obtain M frequency domain reference feature vectors;
performing Fourier transform on the gesture feature vector to obtain a frequency domain gesture feature vector;
performing similarity calculation on the frequency domain gesture feature vector and the M frequency domain reference feature vectors in sequence to obtain the similarities between the gesture feature vector and the M reference feature vectors in the reference feature vector set.

9. The gesture recognition method according to claim 1, wherein the step of performing hand feature extraction on the image to be recognized to obtain the gesture feature vector comprises steps:
performing hand object detection on the image to be recognized to obtain a to-be-recognized hand object region corresponding to the image to be recognized; and
calling a feature extraction unit of a pre-trained image classification model, and performing feature extraction on a local image to be recognized corresponding to the to-be-recognized hand object region to obtain the gesture feature vector,
wherein the pre-trained image classification model is obtained by training a second sample image set with classification labels, and the feature extraction unit is a backbone network unit that completes network parameter adjustment by a back propagation algorithm in a training process of the pre-trained image classification model.

10. The gesture recognition method according to claim 1, wherein the gesture recognition method is applied to an electronic device, and the image to be recognized is captured by a camera of the electronic device in real time;
wherein after the step of determining the target gesture category of the image to be recognized based on the similarities between the gesture feature vector and the M reference feature vectors in the reference feature vector set, the gesture recognition method further comprises:
controlling the electronic device to perform a target operation corresponding to the target gesture category.

11. The gesture recognition method according to claim 1, wherein the number of the sample images under different gesture categories may be the same or different, and each of the gesture categories comprises at least 2 sample images.

12. The gesture recognition method according to claim 1, wherein gestures in the N sample images of each of the gesture categories are the same, and each of the sample images comprises a corresponding one of the gestures.

13. The gesture recognition method according to claim 4, wherein the vector elements of the N initial feature vectors at a same one of the element positions are different from each other.

14. The gesture recognition method according to claim 6, wherein the M reference feature vectors are vertically spliced to form the reference feature matrix;
wherein in the reference feature matrix, each of rows represents a corresponding one of the reference feature vectors, and each of columns represents a feature dimension in the corresponding one of the reference feature vectors.

15. A gesture recognition device, comprising:
a data acquisition module
a feature extraction module; and
a gesture category determination module;
wherein the data acquisition module is configured to obtain a reference feature vector set corresponding to an image to be recognized and a gesture category set; the gesture category set is predefined and comprises M gesture categories; the reference feature vector set comprises M reference feature vectors corresponding to the M gesture categories, each of the reference feature vectors is obtained by performing vector fusion on initial feature vectors of N sample images of each of the gesture categories, each of the initial feature vectors is obtained by performing hand feature extraction on each of the sample images, and M and N are integers greater than 1;
wherein the feature extraction module is configured to perform hand feature extraction on the image to be recognized to obtain a gesture feature vector;
wherein the gesture category determination module is configured to determine a target gesture category of the image to be recognized based on similarities between the gesture feature vector and the M reference feature vectors in the reference feature vector set.

16. An electronic device, comprising:
a memory; and
at least one processor;
wherein the memory is configured to store computer-executable instructions, and the at least one processor is configured to execute the computer-executable instructions stored in the memory to implement the gesture recognition method according to claim 1.

17. A computer-readable storage medium, comprising:
computer-executable instructions stored therein; or
a computer program stored therein;
wherein the computer-executable instructions or the computer program is executed by at least one processor to implement the gesture recognition method according to claim 1.
